(19) United States
(12) Patent Application Publication
(10) Pub. No.: US 2007/0052262 A1
(43) Pub. Date: Mar. 8, 2007

(54) Structural element, use of a structural element and method for producing a structural element, particularly a cross member for a vehicle

(75) Inventor: Walter Wolf, Oppenweiler-Zell (DE)

Correspondence Address: FOLEY AND LARDNER LLP;SUITE 500, 3000 K STREET NW, WASHINGTON, DC, 20007, US

(73) Assignees: Behr GMBH & CO KG; Walter Wolf

(21) Appl. No.: 10/574,709

(22) PCT Filed: Oct. 8, 2004
(86) PCT No.: PCT/EP04/11276

§ 371 Date: Apr. 5, 2006

(30) Foreign Application Priority Data
Oct. 8, 2003 (DE) 10347230.4

(51) Int. Cl. B60K 37/00

(52) U.S. Cl. 296/208

(57) ABSTRACT

The invention relates to a structural element (1), particularly a cross member, for placing between A pillars of a motor vehicle, comprising a base body (2), which is provided, in essence, as a hollow profile, and which, inside, has a plastic core (4) that forms at least one channel (6), whereby the base body (2) has an at least partially perforated design.

The invention relates to a structural element, in particular to a cross member for arranging between A-pillars of a motor vehicle, and to the use of a structural element of this type. Furthermore, the invention relates to a method for producing a structural element of this type.

Cross members comprising tubes are known from motor vehicle engineering, said cross members being composed of metal and having correspondingly large wall thicknesses. The wall thicknesses are designed here to be suitably thick to provide sufficient dimensional, bending, buckling and torsional stability and therefore sufficient load-bearing capacity under pressure. The cross member which is designed as a tube or hollow profile is suitable in principle for conducting air, for example from an air-conditioning system arranged centrally in the front region of the vehicle to lateral discharge vents.

A cross member of this type is known, for example, from DE 100 64 522 A1. In this case, the cross member is formed, for the purpose of reducing weight, from a light construction material, in particular from a light metal in the manner of a shell component or basic body in which a plastic core forming at least one duct is arranged to provide the cross member with sufficient rigidity and load-bearing capacity under pressure. The duct is provided with openings for the exit of the air flow.

The invention is based on the object of improving the cross member known from the prior art, in particular of improving it with regard to a further reduction in weight.

The object is achieved according to the invention by a structural element having the features of claim 1 and uses of a structural element having the features of claims 15 and 16 and by a method for producing a structural element having the features of claim 17.

Advantageous developments of the invention are the subject matter of the subclaims.

For the greatest possible saving on weight in vehicle construction, a structural element, in particular a cross member, is provided for arranging between A-pillars of a motor vehicle, said cross member having a basic body which is essentially designed as a hollow profile and is provided on the inside with a plastic core forming at least one duct, the basic body being designed such that it is at least partially perforated. The basic body is expediently designed such that it is perforated at least in an opening region, in particular in the region in which a flow exits. In addition to saving on weight, a basic body of this type, which is provided with an opening region designed that it is perforated, has a good reinforcing function for the structure of the structural element.

The basic body is advantageously formed from sheet metal, in particular from a light sheet metal or steel sheet, for example aluminum sheet or refined steel sheet. The perforation of the basic body can be formed, for example, from perforated sheet metal and/or a wire mesh and/or an expanded metal. In a particularly simple embodiment, the basic body is formed from perforated sheet metal. In this case, the wall thickness of the metallic basic body is as thin as possible, so that weight can be saved. For high absorption of deformation energy and high dimensional, flexural and torsional stability while the structural element is at the same time of particularly lightweight construction, the basic body is provided with the plastic core, with the strength being achieved by the bonding of basic body and plastic core. Furthermore, the plastic core brings about sufficiently good insulation, in particular sound insulation and thermal insulation, for example when the structural element is used as an air conduction duct. The plastic core is preferably made from a foam material, for example from a foamed thermoplast, polyurethane foam or a particle foam. For a plastic core having a higher strength, it is preferably formed from foam particles connected to each other via a binder.

For as simple as possible a production of the structural element designed as a hybrid structural element, the basic body is preferably formed from two half bodies, in particular from two half shells. The basic body, in particular its two half bodies, is held together via the plastic core. In addition, the two half bodies can additionally be connected mechanically.

Depending on the type and function and arrangement of the structural element, the basic body preferably has at least one perforated opening region per half body. As an alternative or in addition, the basic body is perforated in an opening region engaging over both half bodies. In other words: a basic body formed from two half shells has an opening region engaging over the shells, i.e. a region covering the upper and the lower shell. Depending on the function, the perforated opening region may completely encircle the basic body. The opening region, in the case of it being provided with a perforation engaging over the half bodies, is preferably provided with a reinforcing element, for example made from plastic or metal. The reinforcing element is expediently arranged parallel to the plane of separation of the half bodies.

For design freedom with regard to the function of the structural element, the basic body can preferably be provided with a plurality of opening regions arranged at a distance from one another, as seen in the longitudinal direction. In this case, the duct can advantageously be designed as a multichamber duct. In particular by means of a retrospective insertion of the plastic core or the plastic structure, freedom in terms of manufacturing and design is provided making possible a structural element with diverse functions. By means of a multichamber duct, for example, an air conduction duct for conducting fresh air, hot air or cold air in separate ducts of the multichamber duct is possible. As an alternative or in addition, one of the chambers can be used as a duct for guiding lines or cables.

In addition to the integration of one or more ducts in the structural element, securing means, connecting points or housing parts of a heating and/or air-conditioning system are preferably integrally formed on the edges, which bear against each other, of the half bodies and/or on the basic body. A structural element designed in such a manner is preferably used as an instrument panel support in a motor vehicle, with the duct being an air conduction duct and/or a cable duct. As an alternative, a structural element designed in such a manner can be used as a cross member, which is arranged below a windshield, in a motor vehicle, the duct being an air conduction duct for conducting an air flow to be supplied to the windshield and/or the side windows, and/or for heating a wiper blade support. The structural element could also be used as a “rear end module”.

In the preferred method for producing a structural element of this type, the basic body is at least partially perforated and formed into a basic shape and placed into a die in which the plastic core is integrally formed on the basic body, for example is injection-molded on it, in a single method step. In other words, the plastic core is connected retrospectively to the metallic basic body or is joined, injected, foamed or placed into the metallic basic body. In this case, a plastic, in particular a thermally activatable foam, such as polyurethane foam, is injected into the basic body where the foam swells and adheres to the basic body. Depending on the specification, the plastic core can have different foam thicknesses, so that the foam profile of the medium in the duct formed by the plastic core is independent of the static structure of the structural element. That is to say, the static or stiffening structure of the plastic core is set by an appropriate foam thickness as a function of the mechanical stressing of the structural element, thus permitting a structural element which is variable in terms of load in some regions.

The advantages obtained by the invention reside in particular in the fact that a structural element which can be used as a cross member, structural element for the front end or structural element, is of particularly lightweight design while at the same time having as good dimensional, flexural, buckling, warping and torsional stability as possible. Depending on the construction, the plastic core forming a duct serves, in particular, for the integration of one or more media-conducting ducts or as a cable duct. The plastic core or the plastic structure can be inserted retrospectively into the basic body. By means of the plastic core and its joining connection to the metallic basic body, an additional connection can be omitted.

Exemplary embodiments of the invention are explained in more detail with reference to a drawing, in which:

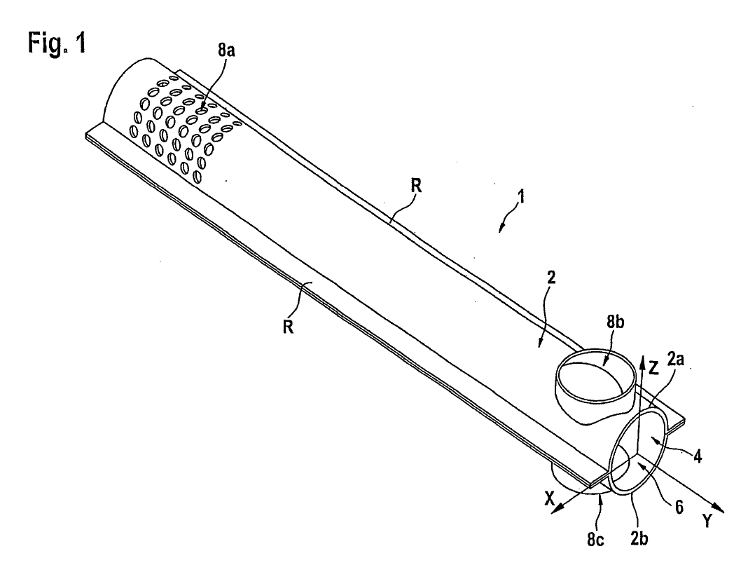

FIG. 1 shows, diagrammatically, a perspective view of a structural element, in particular of a cross member, with an at least partially perforated basic body,

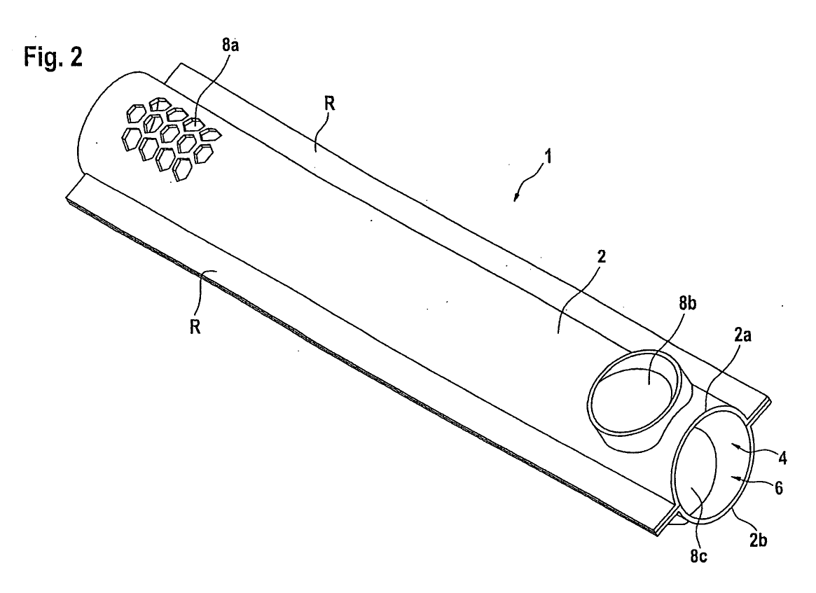

FIG. 2 shows, diagrammatically, a perspective view of an alternative structural element,

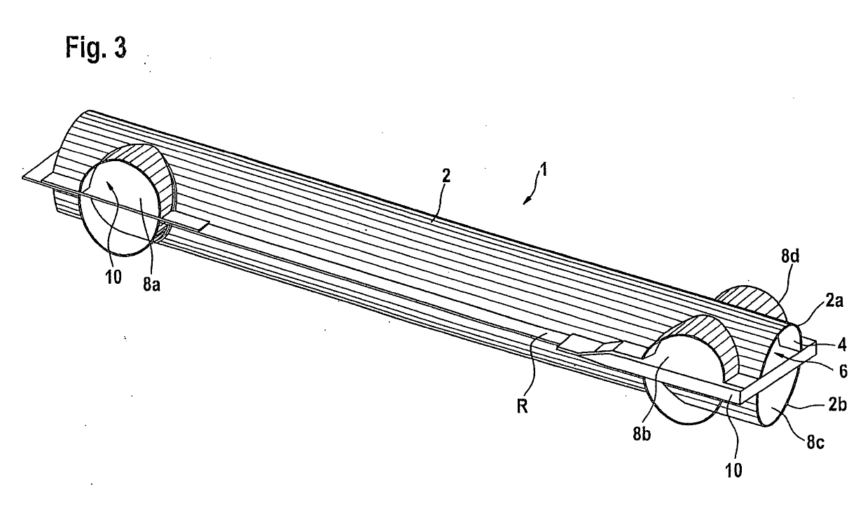

FIG. 3 shows, diagrammatically, a perspective view of an alternative structural element with a reinforcing element arranged in the opening region of the basic body,

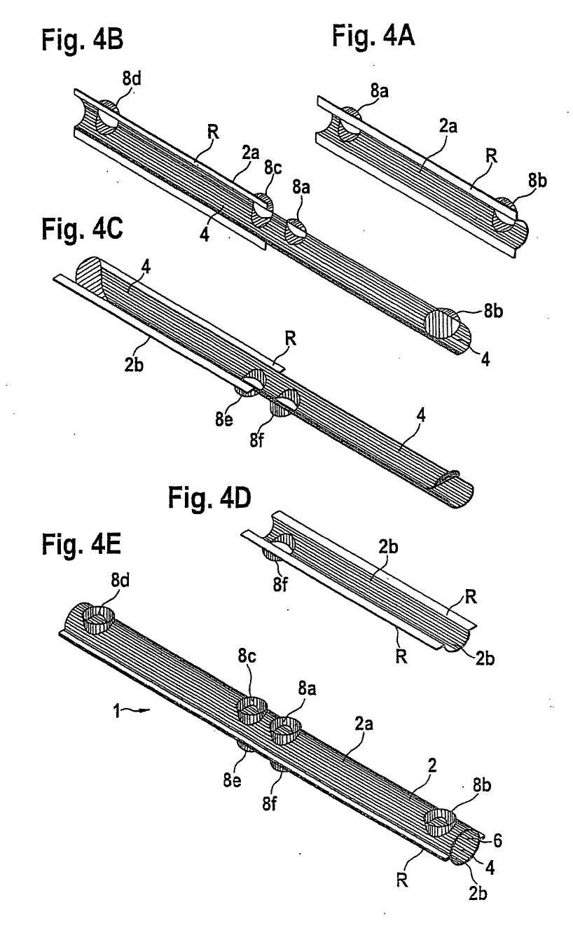

FIGS. 4A to 4C show, diagrammatically, a perspective view of a structural element formed from half bodies,

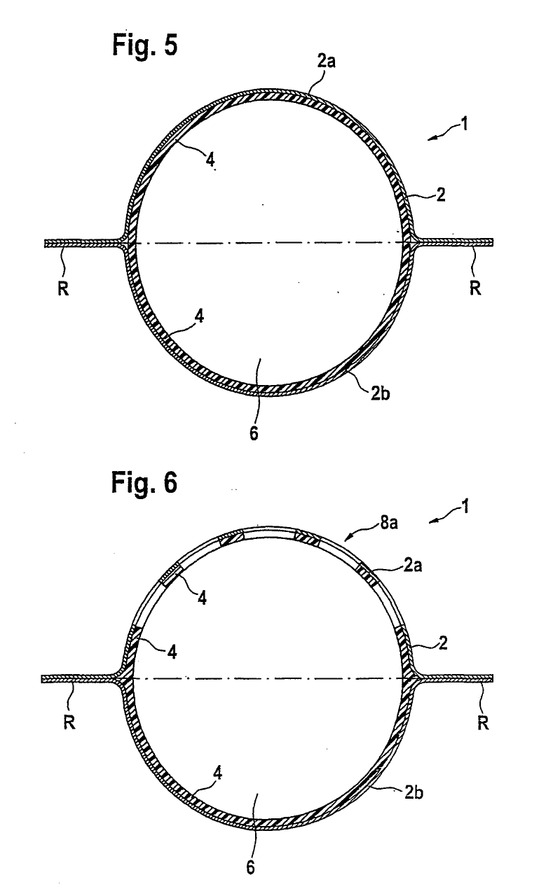

FIG. 5 shows, diagrammatically, a cross section of a structural element,

FIG. 6 shows, diagrammatically, a cross section of a structural element in the region of a perforation,

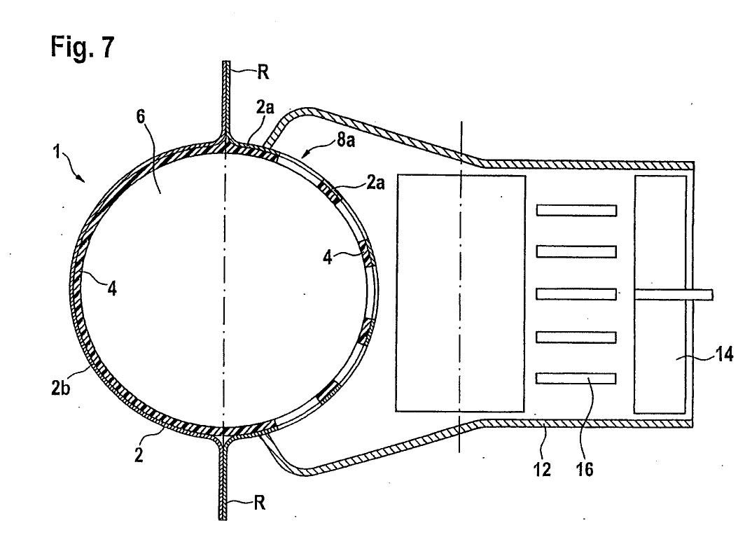

FIG. 7 shows, diagrammatically, a cross section of a structural element according to FIG. 6 with a securing means arranged in the region of the perforation, and

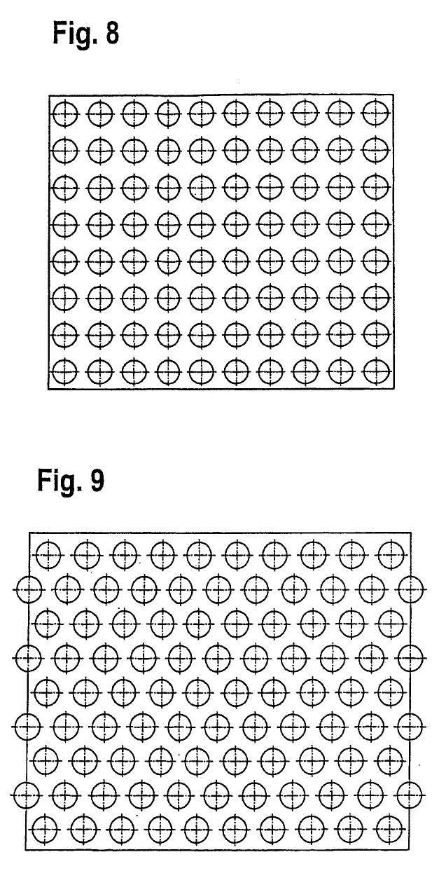

FIGS. 8 to 9 and 10A to 10C show diagrammatically different embodiments for a perforation.

Mutually corresponding parts are provided with the same designations in all of the figures.

FIG. 1 shows a structural element 1, for example a cross member for arranging between A-pillars (not illustrated specifically) of a vehicle (not illustrated specifically). The structural element 1 serves, for example, as an instrument panel support for an air-conditioning and/or heating system. As an alternative, the structural element 1 can serve as a cross member, which is arranged below a windshield, in a vehicle, said cross member being provided as an air conduction duct for air conditioning the vehicle interior and for deicing the windshield.

For this purpose, the structural element 1 has a basic body 2 which is preferably formed from sheet metal, in particular from a light sheet metal, for example from aluminum sheet or refined steel sheet. In the exemplary embodiment, the basic body 2 is designed as a hollow profile, in particular is of tubular design. As an alternative, the basic body 2 may also be designed as a hollow profile with a polygonal cross section (not illustrated specifically). Furthermore, the basic body 2 is formed from two half bodies 2a and 2b, for example two half shells—a lower shell and an upper shell.

The basic body 2 is provided on the inside with a plastic core 4 which forms a duct 6. The basic body 2, in particular its two half bodies 2a and 2b, is held together via the plastic core 4; in particular, the plastic core 4 is joined to the basic body 2. For this purpose, the plastic is placed into the basic body 2, for example in an injection-molding process. As an alternative and depending on the type of plastic, the plastic may also be foamed into place, cast into place or inserted in a similar manner.

The basic body 2 can additionally be connected mechanically. For example, the basic body 2 can be riveted, screwed or connected in a similar manner to the edges R, which bear against each other, of the half bodies 2a, 2b.

The duct 6 which is formed by means of the plastic core 4 serves, for example, for the conduction of a medium, in particular air for air conditioning the vehicle interior. As an alternative, the duct 6 may also serve to guide lines or cables. The basic body 2 is provided with a plurality of opening regions 8a to 8c, which are arranged at a distance from one another, as seen in the longitudinal direction, for the entry and/or exit of a medium, for example air, conducted in the duct 6.

The plastic core 4 serves among other things for the rigidity of the basic body 2. The basic body 2, which is of particularly thin-walled design, leads, when air flows through it, to a noise being produced which is particularly advantageously damped by lining the basic body 2 with the plastic core 4. That is to say, the plastic core 4 takes on, inter alia, sound insulation and, if appropriate, also thermal insulation.

For a particularly lightweight design of the structural element 1, its basic body 2 is designed such that it is at least partially perforated. The basic body 2 is preferably designed such that it is perforated in one of the opening regions 8a. As an alternative, the basic body 2 can be designed such that it is perforated in a plurality of or in all of the opening regions 8a to 8c. Perforation is understood here as meaning a multiplicity of holes which are spaced apart from one another and are arranged in rows and/or columns with a hole pattern. In the very simplest embodiment, the basic body 2 is formed from perforated sheet metal. In the case of a duct 6 serving as a means of conducting air, the perforated opening region 8a may be an air exit for the air to be conducted into the vehicle interior.

As illustrated in FIG. 1, the basic body 2 is designed such that it is perforated in the opening region 8a of the upper half body 2a. Depending on the type and design of the basic body 2, it can have one perforated opening region 8a per half body 2a, 2b.

FIG. 2 illustrates an alternative embodiment for a structural element 1. Instead of a hole pattern in the perforated opening region 8a that has round holes, said opening region has a hole pattern having polygons (=hexagonal hole pattern). In comparison to the hole pattern in the opening region 8a according to FIG. 1, the hexagonal hole pattern leads to a lower accumulation of material between the holes and therefore to a further reduction in the weight.

FIG. 3 shows an alternative embodiment for the structural element 1, the opening regions 8a to 8d being arranged such that they engage over the half bodies 2a, 2b. Depending on type and design, the opening regions 8a to 8d covering the two half bodies 2a, 2b may also be designed such that they are perforated (not illustrated specifically). To provide sufficiently good rigidity for these opening regions 8a to 8d too, they are provided with a reinforcing element 10. The reinforcing element 10 is preferably arranged parallel to the plane of separation of the half bodies 2a, 2b and is formed from plastic. The reinforcing element 10 is fitted in a manufacturing step as described above, for example by injection, in the process of joining the basic body 2 to the plastic core 4.

FIGS. 4A to 4E show, in a perspective illustration, the individual elements of the structural element 1. FIG. 4A illustrates part of a metallic upper shell—part of a half body 2a of the basic body 2. FIG. 4B shows the inner lining of the upper half body 2a with a plastic core 4. FIG. 4C shows the inner lining of the lower half body 2b with the plastic core 4. FIG. 4D shows part of the lower half body 2b. In FIG. 4E, all of the elements of the structural element 1 are illustrated joined together and form, for example, a cross member with a plurality of opening regions 8a to 8f.

FIG. 5 shows, diagrammatically, a cross section through a structural element 1 with a basic body 2 made from an upper and lower half body 2a, 2b, which half bodies are lined on the inside with a plastic core 4. In the joined together state of the structural element 1, a duct 6 is formed in the interior of the plastic core 4. The duct 6 can be designed, in a manner not illustrated specifically, as a multichamber duct. For this purpose, the duct 6 is divided by walls into a plurality of chambers, with, for example, the one serving for the conducting of fresh air, another chamber duct serving for the conducting of hot air. FIG. 6 shows, diagrammatically, a cross section of the structural element 1 in the region of a perforated opening region 8a.

FIG. 7 likewise shows the structural element 1 in the region of the perforated opening region 8a in cross section. In this case, a housing part 12 is arranged on the basic body 2 in the opening region 8a, which housing part serves, for example, as a flow exit and is provided with corresponding exit openings 14 and/or deflecting means 16. As an alternative or in addition, further securing means, connecting points or housing parts 12 of a heating and/or air-conditioning system can be integrally formed on the basic body 2 in a manner not illustrated specifically.

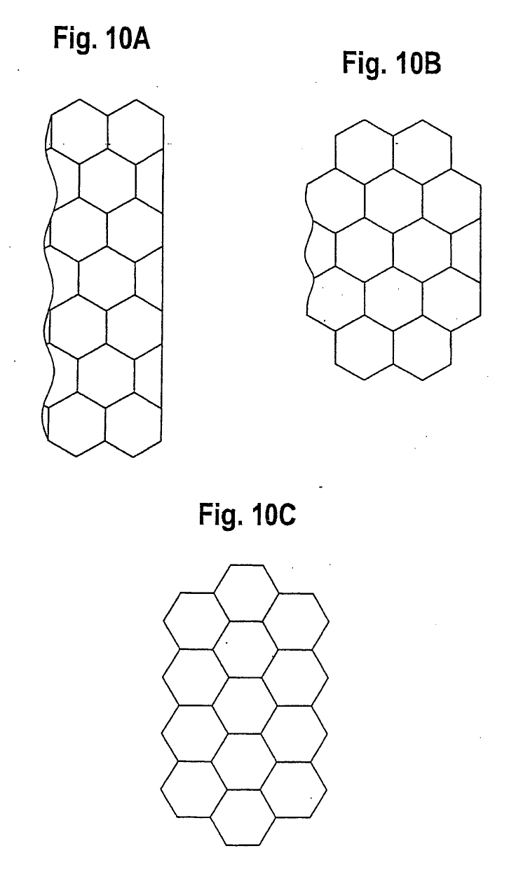

FIGS. 8 and 9 and 10A to 10C show various embodiments of the hole pattern of a perforated opening region 8a to 8f. In FIG. 8, for example, a hole pattern with holes which are arranged parallel to one another and form a square arrangement of holes is illustrated and, in FIG. 9, a hole pattern with holes which are arranged offset to one another and form an offset arrangement of holes is illustrated. FIGS. 10A to 10C show various hole patterns for different arrangements of hexagonal holes. The diversity of the hole pattern and of the arrangement and the shape of the holes is not subject to any limits. The type, arrangement and the shape depend on the function of the associated opening region 8a to 8f.

### LIST OF DESIGNATIONS

1 Structural element
2 Basic body
2a, 2b Half bodies
4 Plastic core
6 Duct
8a to 8f Opening regions
10 Reinforcing element
12 Housing part
R Edge

1. A structural element, in particular cross member for arranging between A-pillars of a motor vehicle, with a basic body which is essentially designed as a hollow profile and is provided on the inside with a plastic core forming at least one duct, the basic body being designed such that it is at least partially perforated.

2. The structural element as claimed in claim 1, the basic body being designed such that it is perforated at least in an opening region, in particular in the region in which a flow exit.

3. The structural element as claimed in claim 1, the basic body being formed from sheet metal, in particular from steel sheet or light sheet metal.

4. The structural element as claimed in claim 1, the perforation of the basic body being formed from perforated sheet metal and/or a wire mesh and/or an expanded metal.

5. The structural element as claimed in claim 1, the basic body being formed from two half bodies, in particular from two half shells.

6. The structural element as claimed in claim 1, the basic body, in particular its two half bodies, being held together via the plastic core.

7. The structural element as claimed in claim 5, the two half bodies additionally being connected mechanically.

8. The structural element as claimed in claim 5, the basic body being perforated in one opening region per half body.

9. The structural element as claimed in, the basic body being perforated in an opening region engaging over both half bodies.

10. The structural element as claimed in claim 9, the opening region, in the case of it being provided with a perforation engaging over the half bodies, being provided with a reinforcing element.

11. The structural element as claimed in claim 10, the reinforcing element being arranged parallel to the plane of separation of the half bodies.

12. The structural element as claimed in claim 1, the basic body being provided with a plurality of opening regions which are arranged at a distance from one another, as seen in the longitudinal direction.

13. The structural element as claimed in claim 1, the duct being designed as a multichamber duct.

14. The structural element as claimed in claim 1, with securing means, connecting points or housing parts of a heating and/or air-conditioning system being integrally formed on the edges, which bear against each other, of the half bodies and/or on the basic body.

15. Use of a structural element as claimed in claim 1 as an instrument panel support in a motor vehicle, the duct being an air conduction duct and/or a cable duct.

16. The use of a structural element as claimed in claim 1 as a cross member, which is arranged below a windshield, in a motor vehicle, the duct being an air conduction duct for conducting an air flow to be supplied to the windshield and/or the side windows, and/or for heating a wiper blade support.

17. A method for producing a structural element as claimed in claim 1, the basic body being at least partially perforated and being formed into a basic shape and being placed into a die in which the plastic core is integrally formed on the basic body, for example is injection-molded on, in a single method step.
